(19) United States
(12) Patent Application Publication
(10) Pub. No.: US 2014/0298187 A1
(43) Pub. Date: Oct. 2, 2014

(54) DIALING METHOD, DIALING DEVICE, MOBILE TERMINAL AND STORAGE MEDIUM

(71) Applicant: TENCENT TECHNOLOGY (SHENZHEN) COMPANY LIMITED, Shenzhen (CN)

(72) Inventors: Ting SHEN, Shenzhen (CN); Jiayao FENG, Shenzhen (CN); Fangmin LIU, Shenzhen (CN)

(21) Appl. No.: 14/302,858

(22) Filed: Jun. 12, 2014

Related U.S. Application Data
(63) Continuation of application No. PCT/CN2013/087441, filed on Nov. 19, 2013.

(30) Foreign Application Priority Data
Jan. 29, 2013 (CN) 201310033203.6

(51) Int. Cl. G06F 3/0482; G06F 3/0484

(52) U.S. Cl. CPC G06F 3/0482; G06F 3/04847
USPC 715/739

(57) ABSTRACT

The present invention relates to instant communications and provides a dialing method, a dialing device, a mobile terminal and a storage medium, and the method comprises: drawing a slider on a main interface, which is a screen lock interface or any desktop interface; receiving a dialing startup instruction from the slider, and obtaining N contact identifiers from a contact list, where N is an integer no less than 1; drawing dial object identifiers on the main interface; and obtaining a first contact identifier selected by a user from the dial object identifiers, and dialing a phone number associated with the first contact identifier. With the invention, the dialing operation flow may be shortened, the dialing speed may be improved, and direct dialing on the desktop of a mobile terminal may be supported; at the same time, the dialing gesture may be enriched, and user experience may be improved greatly.

### CROSS-REFERENCE TO RELATED APPLICATION

This application claims priority to and is a continuation application of PCT/CN2013/087441, filed on November 19, 2013 and entitled “DIALING METHOD, DIALING DEVICE, MOBILE TERMINAL AND STORAGE MEDIUM”, which claims the benefit of Chinese Application No. 201310033203.6 filed on Jan. 29, 2013, by Tencent Technology (Shenzhen) Co., Ltd., titled “Dialing Method, Dialing Device, Mobile Terminal and Storage Medium”, which are incorporated herein by reference in their entirety.

### FIELD OF THE INVENTION

The present disclosure relates to the technical field of instant communications, and in particular, to a dialing method, a dialing device, a mobile terminal and a storage medium.

### BACKGROUND OF THE INVENTION

At present, mobile terminals have become an indispensable tool for the communication among people, and a number dialing function of the mobile terminal is one of the mostly used functions. A rapid and easily-operated dialing mode in a mobile terminal improves the user experience, thereby improving the acceptability of the mobile terminal. In the existing Android 4.2 operating system, there provides a method for opening a dialing pad including numbers 0-9 on a screen lock interface via a sliding gesture; with this method, the unlock steps can be reduced and direct dialing can be realized. In this case, however, a phone number shall be directly inputted for dialing, as a result, the dialing takes much time due to the lengthy dialing operation flow. That is, the existing call record or contact list cannot be accessed rapidly from the screen lock interface, although it is possible to trigger dialing on the screen lock interface. Moreover, the gesture for triggering the dialing pad is simplex, and direct dialing on the desktop of the mobile terminal is not supported in the method.

### SUMMARY OF THE INVENTION

The embodiments of the invention provide a dialing method, a dialing device, a mobile terminal and a storage medium, thereby solving at least a part of the problems of the existing dialing method, i.e. the long dialing operation flow and the slow dialing speed, the lack of capability to support rapid invoking of the existing call record from a screen lock interface (instead, the existing dialing method supports to trigger only a dialing pad on the screen lock interface, moreover, the gesture for triggering the dialing pad is simple), and the lack of capability of direct dialing on the desktop of a mobile terminal.

One aspect of the invention provides a dialing method, comprising:

drawing a slider on a main interface, which is a screen lock interface or any desktop interface;

receiving a dialing startup instruction from the slider, and obtaining N contact identifiers from a contact list, where N is an integer no less than 1;

drawing dial object identifiers on the main interface; and

obtaining a first contact identifier selected by a user from the dial object identifiers, and dialing a phone number associated with the first contact identifier.

Another aspect of the invention provides a dialing device, comprising:

a slider drawing unit, configured to draw a slider on a main interface, which is a screen lock interface or any desktop interface;

an identifier obtaining unit, configured to receive a dialing startup instruction from the slider and to obtain N contact identifiers from a contact list, where N is an integer no less than 1;

an identifier drawing unit, configured to draw dial object identifiers on the main interface; and

a first dialing unit, configured to obtain a first contact identifier selected by a user from the dial object identifiers, and to dial a phone number associated with the first contact identifier.

Yet another aspect of the invention provides a mobile terminal, which comprises a dialing device as described above.

Still another aspect of the invention provides a storage medium containing executable instructions, which, when executed by a processor, are configured to perform a dialing method as described above.

In the dialing method, the dialing device, the mobile terminal and the storage medium according to the embodiments of the invention, by the steps of: drawing a slider on a main interface, which may be a screen lock interface or any desktop interface; receiving a dialing startup instruction from the slider, and obtaining N contact identifiers from the contact list, where N is an integer no less than 1; drawing dial object identifiers on the main interface, where the dial object identifiers include the N contact identifiers; and obtaining a first contact identifier selected by a user from the dial object identifier, and dialing a phone number associated with the first contact identifier, the dialing operation flow may be shortened, the dialing speed may be improved, and direct dialing on the desktop of a mobile terminal may be supported; at the same time, the dialing gesture may be enriched, and user experience may be improved greatly.

### BRIEF DESCRIPTION OF THE DRAWINGS

In order to clearly illustrate the technical solutions of the embodiments of the invention, the drawings referred to in the description of the embodiments will be briefly introduced below. However, the drawings in the description below illustrate only some embodiments of the invention, and modifications and substitutions may be further made on these drawings by one of ordinary skills in the art without creative work.

FIG. 1 is a flow chart of a dialing method according to a first embodiment of the invention;

FIG. 2 is a schematic diagram of an interface according to the first embodiment of the invention, on which only a slider is shown;

FIG. 3 is a schematic diagram of an interface according to the first embodiment of the invention, on which a slider and identifiers are shown;

FIG. 4 is a flow chart of a dialing method according to a second embodiment of the invention;

FIG. 5 is a specific structural block diagram of a dialing device according to a third embodiment of the invention; and

FIG. 6 is a specific structural block diagram of a dialing device according to a fourth embodiment of the invention.

### DETAILED DESCRIPTION OF THE EMBODIMENTS

In order to make the technical solutions and advantages of the invention more apparent, the invention will be further illustrated in detail below in conjunction with the drawings and embodiments. It should be noted that, the specific embodiments described herein are only used to explain the invention, rather than limiting the scope of the invention.

In the embodiments of the invention, a slider is drawn on a main interface, which may be a screen lock interface or any desktop interface; a dialing startup instruction is received from the slider, and N contact identifiers are obtained from a contact list, where N is an integer no less than 1; dial object identifiers are drawn on the main interface, so that the user can select a first contact identifier from the dial object identifiers and dial a phone number associated with the first contact identifier.

The implementation of the invention will be described in detail below in conjunction with specific embodiments.

### First Embodiment

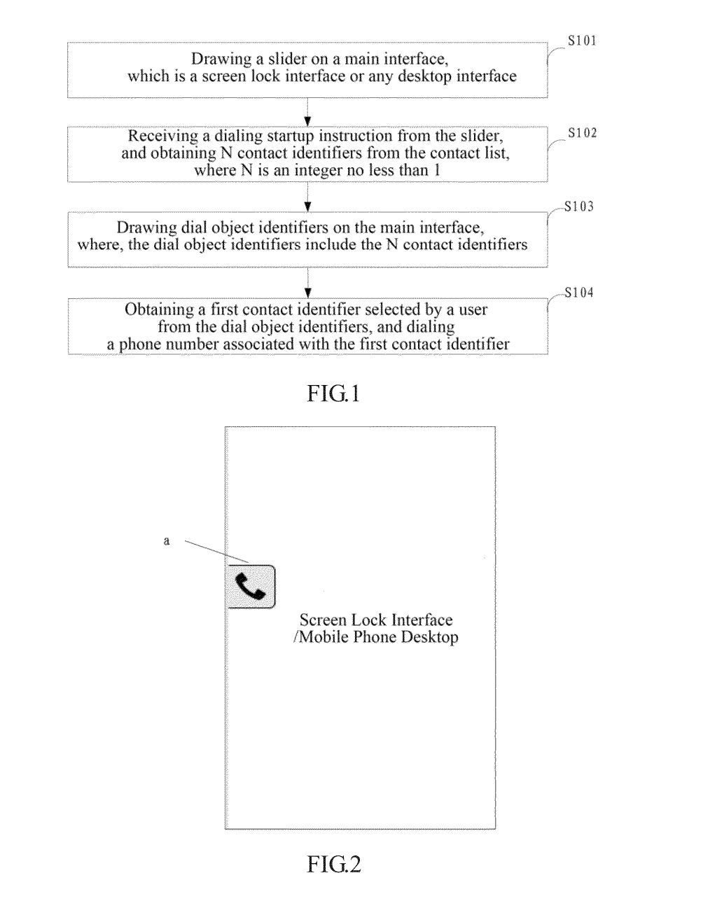

FIG. 1 shows an implementing flow of a dialing method according to the first embodiment of the invention, specifically including Steps S101-S104 as follows.

At Step S101, a slider is drawn on a main interface, which may be a screen lock interface or any desktop interface.

In this embodiment, the main interface may be the screen lock interface or any desktop interface. The slider is a slidable control for starting displaying a contact identifier and a call record entry identifier on the main interface, and is referred to by a reference numeral a in FIG. 2. The mobile terminal may draw the slider a on the main interface.

At Step S102, a dialing startup instruction is received from the slider a, and N contact identifiers are obtained from the contact list, where N is an integer no less than 1.

In this embodiment, the dialing startup instruction is used to instruct the mobile terminal to draw a contact identifier and a call record entry identifier on the main interface, and is triggered by a corresponding operation on the slider, for example, clicking a certain identifier or moving the slider to the coordinates of a certain identifier. The contact list is a list provided by an instant communication tool for saving contact information, and a contact coefficient between the user and a contact is counted and recorded in the contact list, where the contact coefficient includes a recent call frequency or a recent total call duration. The contact identifier includes any one of or a combination of a contact name and a head portrait, and is used by the user to identify different contacts. N is specifically set according to the preference of the user, and is preferably 5. The N contact identifiers are not fixed; instead, the N contact identifiers may change as the contact coefficients between the user and the contacts change. The mobile terminal may select N contacts with a high recent call frequency or a long recent total call duration from the contact list, that is, the mobile terminal selects the most frequently communicated N contacts, and obtains the N contact identifiers of the N contacts. The mobile terminal receives a dialing startup instruction from the slider, and obtains N contact identifiers from the contact list.

At Step S103, dial object identifiers are drawn on the main interface, for example, the dial object identifiers include the N contact identifiers.

In this embodiment, exemplarily, the dial object identifiers include the N contact identifiers. After the mobile terminal obtains the N contact identifiers, drawing the dial object identifiers on the main interface by the mobile terminal includes:

drawing the N contact identifiers on the main interface side by side on a semicircle centered by the slider, where the radius of the semicircle specifically depends on N.

Preferably, on the main interface, the N contact identifiers are drawn side by side on a circle centered by the slider, where the radius of the circle specifically depends on N.

Briefly, the dial object identifiers are drawn around the slider for easy selection by the user, and the protection scope of the invention is not limited by the specific surrounding pattern of the dial object identifiers .

At Step S104, a first contact identifier selected by the user from the dial object identifiers is obtained, and a phone number associated with the first contact identifier is dialed.

In this embodiment, the first contact identifier is any contact identifier selected from the dial object identifiers by the user. When the dial object identifiers include the N contact identifiers, the mobile terminal obtains the first contact identifier selected by a user from the dial object identifiers and dials a phone number associated with the first contact identifier, which is exemplarily described in the following two cases.

In the first case, information of a sliding operation made by the user on the slider is received, and the coordinate information of the slider is obtained. The first contact identifier is selected if the current coordinates of the slider coincide with the coordinates of the first contact identifier among the N contact identifiers, and a phone number associated with the first contact identifier is dialed.

Specifically, after the N contact identifiers are drawn on the main interface, when the current coordinates of the slider are moved to and coincide with the coordinates of the first contact identifier, a phone number associated with the first contact identifier is dialed.

Preferably, the N contact identifiers are N frequent contact identifiers with the top contact coefficients, i.e., N contact identifiers with the top recent call frequencies or the top recent total call durations. Preferably, the mobile terminal may also receive N contacts set by the user, and then obtain N contact identifiers according to user settings.

In the other case, information of a non-sliding operation made by the user on the slider is received; and if the user selects a first contact identifier from the N frequent contact identifiers by the non-sliding operation (for example, an exemplary non-sliding selecting operation is clicking, or single touch), a phone number associated with the first contact identifier is dialed.

Specifically, after the N contact identifiers are drawn on the main interface, the mobile terminal receives a first contact identifier selected by the user from the N contact identifiers, and dials a phone number associated with the selected first contact identifier.

An exemplary application of the present embodiment is described below in an example where a slider, a call record icon and head portraits of 4 frequent contacts on the screen lock interface are taken as the specific target objects.

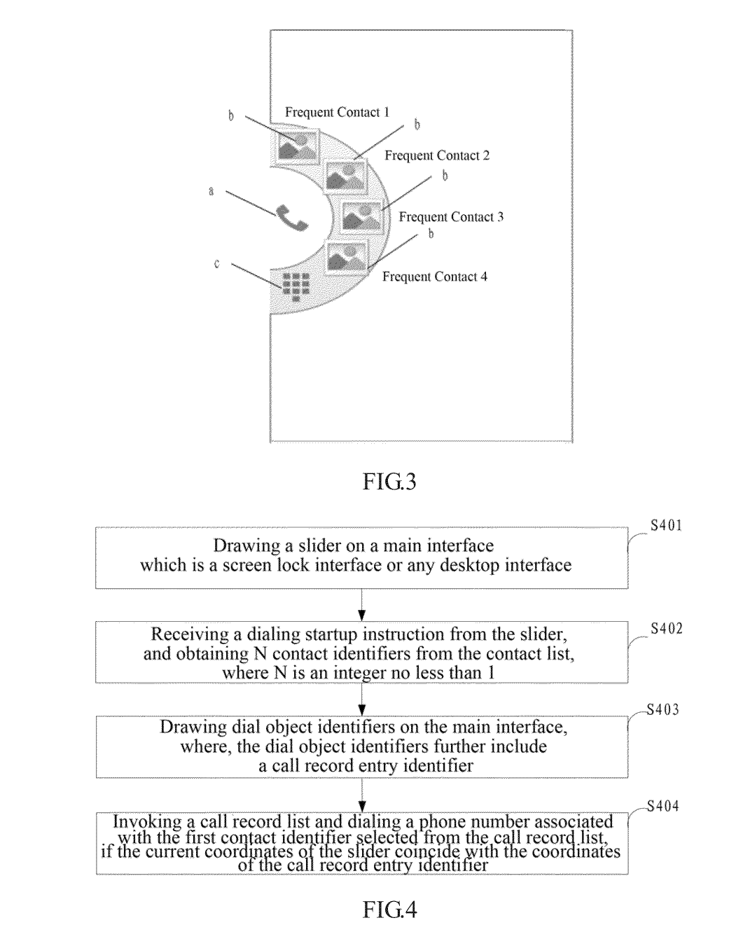

The slider a is drawn on the screen lock interface by the mobile terminal, as shown in FIG. 2. Then, after receiving a click event on the slider a, head portraits b of 4 frequent contacts with the top call frequencies are obtained from a contact list according to the call frequency by the terminal. Particularly, when a user clicks on the slider a, the head portraits b of the 4 frequent contacts are drawn on the screen lock interface, as shown in FIG. 3; and if one of the displayed head portraits b of the frequent contacts corresponds to the contact to be called by the user, then the user may long-press and drag the slider a onto the head portrait b of the frequent contact, or the user may click on the head portrait b of a certain frequent contact after releasing the slider a, to dial a phone number corresponding to the head portrait b of the frequent contact.

In this embodiment, the phone number of a frequent contact may be rapidly dialed via a simple operation on the screen lock interface or the desktop, so that the dialing operation flow is shortened, the dialing speed is improved, and direct dialing on the desktop of a mobile terminal is supported; at the same time, the dialing gesture may be enriched, thereby significantly improving user experience.

### Second Embodiment

FIG. 4 shows an implementing flow of a dialing method according to the second embodiment of the invention, specifically including Steps S401-S404 as follows.

At Step S401, a slider is drawn on a main interface, which may be a screen lock interface or any desktop interface.

At Step S402, a dialing startup instruction is received from the slider, and N contact identifiers are obtained from a contact list, where N is an integer no less than 1.

At Step S403, the dial object identifiers are drawn on the main interface, exemplarily, the dial object identifiers include a call record entry identifier.

In this embodiment, the Steps S401-S403 are similar to the Steps S101-S103 in the above first embodiment, and reference may be made to the description of the above first embodiment.

At Step S404, information of a sliding operation made by the user on the slider is received, and the coordinate information of the slider is obtained. If the current coordinates of the slider coincide with the coordinates of the call record entry identifier, a call record list is invoked and a phone number associated with a first contact identifier selected from the call record list is dialed. Or, information of a non-sliding selecting operation made by the user on the call record entry identifier is received, and if the user selects the call record entry identifier by the non-sliding selecting operation, a call record list is invoked and a phone number associated with a first contact identifier selected from the call record list is dialed.

In this embodiment, when the contact to be dialed is not present among the dial object identifiers, the mobile terminal invokes a call record list when the coordinates of the slider are moved to coincide with the coordinates of the call record entry identifier, then receives a first contact identifier selected by the user from the call record list and dials a phone number associated with the first contact identifier. Or, when the contact to be dialed is not present among the dial object identifiers, the mobile terminal invokes a call record list if the call record entry identifier is clicked, then receives a first contact identifier selected by the user from the call record list and dials a phone number associated with the first contact identifier.

An exemplary application of the present embodiment is described below in an example where a slider, a call record icon and head portraits of 4 frequent contacts on the screen lock interface are taken as the specific target objects.

The slider a is drawn on the screen lock interface by the mobile terminal, as shown in FIG. 2. Then, after receiving a click event on the slider a, head portraits b of 4 frequent contacts with the top call frequencies are obtained from a contact list according to the call frequency by the terminal. Particularly, when a user clicks on the slider a, a call record icon c and the head portraits b of the 4 frequent contacts are drawn on the screen lock interface, as shown in FIG. 3; and if the contact to be dialed by the user is not present among the displayed frequent contacts, the user may long-press and drag the slider a onto the call record icon c; or the user may click on the call record icon c after releasing the slider a to invoke the existing call record list, and then selects a first contact from the call record list and dials the phone number corresponding to the selected first contact.

In this embodiment, the call record list may be rapidly invoked via a simple operation on the screen lock interface or the desktop for the purpose of rapid dialing, so that it is possible to rapidly invoke the existing call record from the screen lock interface, and user experience may be improved greatly.

### Third Embodiment

FIG. 5 shows a specific structural block diagram of a dialing device according to the third embodiment of the invention. For the sake of illustration, only parts related to the present embodiment of the invention are shown. In this embodiment, the dialing device includes: a slider drawing unit 51, an identifier obtaining unit 52, an identifier drawing unit 53 and a first dialing unit 54.

The slider drawing unit 51 is adapted to draw a slider on a main interface, which may be a screen lock interface or any desktop interface.

The identifier obtaining unit 52 is adapted to receive a dialing startup instruction from the slider, and obtain N contact identifiers from a contact list, wherein N is an integer no less than 1.

The identifier drawing unit 53 is adapted to draw dial object identifiers on the main interface, where the dial object identifiers include the N contact identifiers.

The first dialing unit 54 is adapted to obtain a first contact identifier selected by a user from the dial object identifier, and dial a phone number associated with the first contact identifier.

Moreover, the identifier drawing unit 53 is specifically adapted to draw the N contact identifiers on the main interface side by side on a semicircle centered by the slider, where the radius of the semicircle specifically depends on N.

Moreover, the first dialing unit 54 is specifically adapted to: select a first contact identifier among the N contact identifiers and dial a phone number associated with the first contact identifier, if the current coordinates of the slider coincide with the coordinates of the first contact identifier; and if the user clicks on and selects the first contact identifier from the N contact identifiers, a phone number associated with the first contact identifier is dialed.

The dialing device according to the embodiment of the invention may be applied in the above corresponding method in the first embodiment, and reference may be made to the description of the above first embodiment, and further description will not be given again.

### Fourth Embodiment

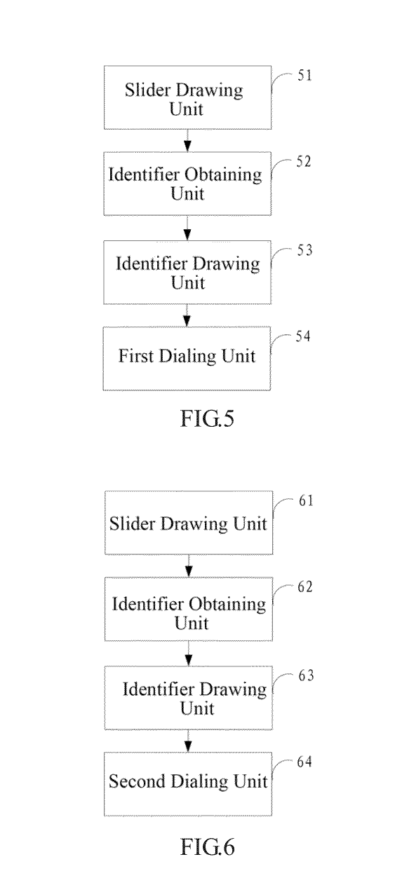

FIG. 6 shows a specific structural block diagram of a dialing device according to the fourth embodiment of the invention. For the sake of illustration, only parts related to the present embodiment of the invention are shown. In this embodiment, the dialing device includes: a slider drawing unit 61, an identifier obtaining unit 62, an identifier drawing unit 63 and a second dialing unit 64.

The slider drawing unit 61 is adapted to draw a slider on a main interface, which may be a screen lock interface or any desktop interface.

The identifier obtaining unit 62 is adapted to receive a dialing startup instruction from the slider and obtain N contact identifiers from a contact list, where N is an integer no less than 1.

The identifier drawing unit 63 is adapted to draw the dial object identifiers on the main interface, where the dial object identifier further includes a call record entry identifier;

The second dialing unit 64 is adapted to: invoke a call record list and dial a phone number associated with a first contact identifier selected from the call record list, if the current coordinates of the slider coincide with the coordinates of the call record entry identifier; or invoke the call record list and dial a phone number associated with the first contact identifier selected from the call record list, if the user clicks on the call record entry identifier.

Moreover, the identifier drawing unit 63 is specifically adapted to draw the N contact identifiers on the main interface side by side on a semicircle centered by the slider, where the radius of the semicircle specifically depends on N.

The dialing device according to the present embodiment of the invention may be applied to the method as described in the second embodiment, and reference may be made to the description of the above second embodiment, and further description will not be given again here.

It should be noted that, in the above system embodiments, the various units included in the system are divided according to the functional logic, but are not limited to such division, so long as the corresponding function can be implemented. In addition, the specific name of each functional unit is only used for distinction, rather than limiting the protection scope of the invention.

An embodiment of the invention further provides a mobile terminal, which includes a dialing device as described above.

Exemplarily, the mobile terminal includes a slider drawing unit 51, an identifier obtaining unit 52, an identifier drawing unit 53, and at least one of a first dialing unit 54 and a second dialing unit 64.

The slider drawing unit 51 is adapted to draw a slider on a main interface, which may be a screen lock interface or any desktop interface.

The identifier obtaining unit 52 is adapted to receive a dialing startup instruction from the slider and obtain N contact identifiers from a contact list, where N is an integer no less than 1.

The identifier drawing unit 53 is adapted to draw dial object identifiers on the main interface.

The first dialing unit 54 is adapted to obtain a first contact identifier selected by a user from the dial object identifiers and dial a phone number associated with the first contact identifier.

The second dialing unit 64 is adapted to invoke a call record list and dial a phone number associated with the first contact identifier selected from the call record list, if the user selects the call record entry by a sliding or non-sliding operation.

An embodiment of the invention further provides a storage medium containing executable instructions, which, when executed by a processor, are configured to perform any one of the above methods for dialing.

Exemplarily, the method includes steps of:

Step S1: Drawing a slider on a main interface, which may be a screen lock interface or any desktop interface;

Step S2: Receiving a dialing startup instruction from the slider, and obtaining N contact identifiers from a contact list, where N is an integer no less than 1;

Step S3: Drawing dial object identifiers on the main interface, exemplarily, where the dial object identifiers include the N contact identifiers and/or a call record entry identifier; and

Step S4: Obtaining a first contact identifier selected by a user from the dial object identifiers, and dialing a phone number associated with the first contact identifier.

Additionally, it may be understood by those ordinary skilled in the art that the storage medium may be a ROM/RAM, a magnetic disk, a compact disk, etc.

The above description only shows some preferred embodiments of the invention, rather than limiting the scope thereof. All modifications, equivalent substitutions and improvements, etc., without departing from the spirit and principle of the invention, should fall within the protection scope of the invention.

What is claimed is:

1. A dialing method, comprising:
drawing a slider on a main interface, which is a screen lock interface or any desktop interface;
receiving a dialing startup instruction from the slider, and obtaining N contact identifiers from a contact list, wherein N is an integer no less than 1;
drawing dial object identifiers on the main interface; and
obtaining a first contact identifier selected by a user from the dial object identifiers, and dialing a phone number associated with the first contact identifier.

2. The method according to claim 1, wherein, the dial object identifiers comprise the N contact identifiers;
drawing the dial object identifiers on the main interface comprises:
drawing the N contact identifiers on the main interface side by side on a semicircle centered by the slider, wherein the radius of the semicircle specifically depends on N.

3. The method according to claim 1, wherein, the dial object identifiers comprise the N contact identifiers;
obtaining a first contact identifier selected by a user from the dial object identifiers and dialing a phone number associated with the first contact identifier comprises:
receiving information of a sliding operation made on the slider by the user and obtaining coordinate information of the slider; and selecting the first contact identifier among the N contact identifiers and dialing a phone number associated with the first contact identifier, if the current coordinates of the slider coincide with the coordinates of the first contact identifier; or/and
receiving information of a non-sliding selecting operation made by the user on a first contact identifier among the N contact identifiers; and dialing a phone number associated with the first contact identifier, if the user selects the first contact identifier from the N contact identifiers by the non-sliding operation.

4. The method according to claim 2, wherein, the N contact identifiers are N frequent contact identifiers with the top contact coefficient, and the contact coefficient is a recent call frequency or a recent total call duration.

5. The method according to claim 1, wherein, the dial object identifier comprises a call record entry identifier;
drawing the dial object identifiers on the main interface further comprises:
drawing the call record entry identifier on the main interface.

6. The method according to claim 5, wherein, obtaining a first contact identifier selected by a user from the dial object identifiers and dialing a phone number associated with the first contact identifier further comprises:
receiving information of a sliding operation made by the user on the slider and obtaining the coordinate information of the slider; and invoking a call record list and dialing a phone number associated with the first contact identifier selected from the call record list, if the current coordinates of the slider coincide with the coordinates of the call record entry identifier; or/and receiving information of a non-sliding selecting operation made by the user on the call record entry identifier; and
invoking a call record list and dialing a phone number associated with the first contact identifier selected from the call record list, if the user selects the call record entry identifier by the non-sliding operation.

7. A dialing device, comprising:
a slider drawing unit, configured to draw a slider on a main interface which is a screen lock interface or any desktop interface;
a contact identifier obtaining unit, configured to receive a dialing startup instruction from the slider and to obtain N contact identifiers from the contact list, wherein N is an integer no less than 1;
a dial object identifier drawing unit, configured to draw dial object identifiers on the main interface; and
a dialing unit, configured to obtain a first contact identifier selected by a user from the dial object identifiers and to dial a phone number associated with the first contact identifier.

8. The device according to claim 7, wherein, the dial object identifiers comprise the N contact identifiers;
the identifier drawing unit is configured to draw the N contact identifiers on the main interface side by side on a semicircle centered by the slider, wherein the radius of the semicircle specifically depends on N.

9. The device according to claim 7, wherein, the dial object identifiers comprise the N contact identifiers; and the dialing unit comprises a first dialing unit;
the first dialing unit is configured to: receive information of a sliding operation made by the user on the slider, and obtain the coordinate information of the slider; and select the first contact identifier and dial a phone number associated with the first contact identifier, if the current coordinates of the slider coincide with the coordinates of the first contact identifier among the N contact identifiers; or the first dialing unit is configured to: receive information of a non-sliding selecting operation made by the user on the first contact identifier among the N contact identifiers;
and dial a phone number associated with the first contact identifier, if the user selects the first contact identifier from the N contact identifiers by the non-sliding operation.

10. The device according to claim 7, wherein, the dial object identifiers further comprise a call record entry identifier; and the dialing unit comprises a second dialing unit;
the second dialing unit is configured to: receive information of a sliding operation made by the user on the slider, and obtain the coordinate information of the slider; and
invoke a call record list and dial a phone number associated with the first contact identifier selected from the call record list, if the current coordinates of the slider coincide with the coordinates of the call record entry identifier; or/and the second dialing unit is configured to: receive information of a non-sliding selecting operation made by the user on the call record entry identifier; and invoke a call record list and dial a phone number associated with the first contact identifier selected from the call record list, if the user selects the call record entry identifier by the non-sliding operation.

11. A mobile terminal, comprising a dialing device, wherein, the dialing device comprises:
a slider drawing unit, configured to draw a slider on a main interface which is a screen lock interface or any desktop interface;
a contact identifier obtaining unit, configured to receive a dialing startup instruction from the slider and to obtain N contact identifiers from the contact list, wherein N is an integer no less than 1;
a dial object identifier drawing unit, configured to draw dial object identifiers on the main interface; and
a dialing unit, configured to obtain a first contact identifier selected by a user from the dial object identifiers and to dial a phone number associated with the first contact identifier.

12. The mobile terminal of claim 11, wherein the dial object identifiers comprise the N contact identifiers;
the identifier drawing unit is configured to draw the N contact identifiers on the main interface side by side on a semicircle centered by the slider, wherein the radius of the semicircle specifically depends on N.

13. The mobile terminal of claim 11, wherein the dial object identifiers comprise the N contact identifiers; and the dialing unit comprises a first dialing unit;
the first dialing unit is configured to: receive information of a sliding operation made by the user on the slider, and obtain the coordinate information of the slider; and select the first contact identifier and dial a phone number associated with the first contact identifier, if the current coordinates of the slider coincide with the coordinates of the first contact identifier among the N contact identifiers; or the first dialing unit is configured to: receive information of a non-sliding selecting operation made by the user on the first contact identifier among the N contact identifiers;
and dial a phone number associated with the first contact identifier, if the user selects the first contact identifier from the N contact identifiers by the non-sliding operation.

14. The mobile terminal of claim 11, wherein , the dial object identifiers further comprise a call record entry identifier; and the dialing unit comprises a second dialing unit;
the second dialing unit is configured to: receive information of a sliding operation made by the user on the slider, and obtain the coordinate information of the slider; and
invoke a call record list and dial a phone number associated with the first contact identifier selected from the call record list, if the current coordinates of the slider coincide with the coordinates of the call record entry identifier; or/and
the second dialing unit is configured to: receive information of a non-sliding selecting operation made by the user on the call record entry identifier; and invoke a call record list and dial a phone number associated with the first contact identifier selected from the call record list, if the user selects the call record entry identifier by the non-sliding operation.

15. The method according to claim 3, wherein, the N contact identifiers are N frequent contact identifiers with the top contact coefficient, and the contact coefficient is a recent call frequency or a recent total call duration.

16. The method according to claim 2, wherein, the dial object identifier comprises a call record entry identifier;
drawing the dial object identifiers on the main interface further comprises:
drawing the call record entry identifier on the main interface.

17. The device according to claim 8, wherein, the dial object identifiers further comprise a call record entry identifier; and the dialing unit comprises a second dialing unit;
the second dialing unit is configured to: receive information of a sliding operation made by the user on the slider, and obtain the coordinate information of the slider; and
invoke a call record list and dial a phone number associated with the first contact identifier selected from the call record list, if the current coordinates of the slider coincide with the coordinates of the call record entry identifier; or/and the second dialing unit is configured to: receive information of a non-sliding selecting operation made by the user on the call record entry identifier; and invoke a call record list and dial a phone number associated with the first contact identifier selected from the call record list, if the user selects the call record entry identifier by the non-sliding operation.
